(19) United States
(12) Patent Application Publication
(10) Pub. No.: US 2009/0206264 A1
(43) Pub. Date: Aug. 20, 2009

(54) INFRA-RED TEMPERATURE SENSOR

(76) Inventors: Robert Christopher Twiney, Fivehead (GB); Theodore J. Krellner, Emporium, PA (US); Peter J. Straub, St. Marys, PA (US)

Correspondence Address: General Electric Company;GE Global Patent Operation, PO Box 861, 2 Corporate Drive, Suite 648, Shelton, CT, 06484, US

(21) Appl. No.: 12/030,986

(22) Filed: Feb. 14, 2008

(51) Int. Cl. G01J 5/02

(52) U.S. Cl. 250/353

(57) ABSTRACT

An infra-red temperature sensor for sensing the temperature of a medium includes a housing; a thermal infra-red sensor element having a predetermined field of view and disposed in the housing; and a diaphragm closing the housing spaced along an axis from and in the field of view of the thermal sensor element for absorbing on its outer surface heat from the medium and emitting radiation from its inner surface to the thermal sensor element representative of the temperature of the medium.

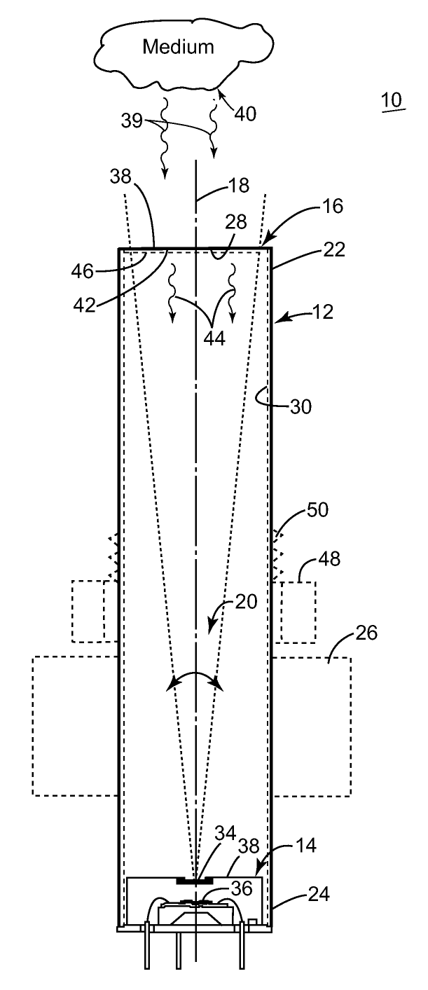

### FIELD OF THE INVENTION

This invention relates to an improved temperature sensor and more particularly to an infra-red sensor suitable for harsh environments.

### BACKGROUND OF THE INVENTION

Thermopile infra-red sensors typically have response times of the order of a few tens of milli-seconds due to the very small thermal mass of the detector element responding to the incoming thermal radiation. However, as with any optical sensor, the detector cannot operate where there is a chance that the window material may get obscured or chemically attacked by contaminants in a harsh environment such as a combustion exhaust stream where temperatures can reach 1000° Celsius and include such harsh materials as hydrochloric and sulfuric acids. There are relatively few good IR window materials suitable for the 1-14 um wavelength band so it is difficult to combine the limited choice of window materials with the needed robustness against fouling and chemical attack. Although well suited for use in measuring high temperatures at high speed due to the fact that they can be used without being in physical contact with the item to be measured, the dependence on a consistent optical path has prevented IR sensors being used in many harsh or aggressive environments.

Current solutions typically use thermocouple, RTD or thermistor units which produce a change in measured voltage or current due to a change in a electrical properties. The time constant of such units is determined by the mass of the thermistor/thermocouple/RTD and the potting and other parts of the protective tip design, typically resulting in time responses to an external temperature change of the order of 10's of seconds. Stable operation of these devices at high temperatures can also still give problems.

### SUMMARY OF THE INVENTION

An improved infra-red temperature sensor according to this invention is robust against harsh and aggressive environments, has a fast response time, is cost effective for volume applications such as exhaust gas monitoring.

An improved infra-red temperature sensor which can operate in harsh environments, yet have fast response time can be achieved with a diaphragm that closes the housing and is spaced along an axis from and in the field of view of a thermal infra-red sensor element for absorbing on its outer surface heat from the medium and emitting radiation from its inner surface to the thermal sensor element representative of the temperature of the medium.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

The FIGURE is a cross-sectional diagrammatic view of a thermal infra-red sensor according to this invention.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

The invention is a device for quickly measuring the temperature of an object especially a gas or liquid stream in a harsh or aggressive environment such as combustion exhaust where the contaminates may include e.g. hydrochloric acid, sulfuric acid, and the temperature may reach a 1,000 degrees Celsius or more. The invention uses an infra-red sensor element with a narrow field of view operating in an enclosed probe housing. The field of view of the sensor is filled by the backside of a thin diaphragm which can be any high temperature material, metallic or ceramic, e.g., aluminum oxide, stainless steel, Inconel which has low thermal mass and high thermal conductivity. One example of which is stainless steel, having a thickness of approximately 20-60 thousandths of an inch which is robust against the temperatures and chemical attacks of the environment. However, due to its low thermal mass the diaphragm changes temperature quickly in response to changes in the temperature of the medium whose temperature is to be measured. These changes in the diaphragm temperature are then measured by the enclosed and protected infra-red sensor element. The diaphragm absorbs on its outer surface heat from the medium whose temperature is to be measured and emits radiation from its inner surface to the thermal sensor element representative of the temperature of the medium. The probe or housing supporting the diaphragm may be an elongate tube, for example, a cylinder such as a right circular cylinder made from a relatively thermally non-conductive material such as steel or ceramic which allows the sensor element at one end of the tube to operate at a much lower ambient temperature than the end where the diaphragm is exposed to the full environmental temperature.

There is shown in the Figure an infra-red temperature sensor 10 according to this invention which includes a probe or housing 12 with a thermal infra-red sensor element 14 disposed in the housing. Thermal infra-red sensor element 14 may include a thermopile and more particularly, a MEMS (Micro Electro Mechanical Systems) thermopile. Diaphragm 16 is spaced from thermal infra-red sensor element 14 along axis 18 and within the predetermined field of view 20 of thermal infra-red sensor element 14. Although diaphragm 16 is shown at one end of housing 12 and thermal infra-red element 14 at the other, this is not a necessary limitation of the invention. That is, neither one of them has to be at the end of the housing.

The housing shown has an elongate shape which may be a cylinder and in fact is shown as a right circular cylinder in the FIGURE. Housing 12 may be made of a low thermal conductivity material such as steel or ceramic in order to reduce the heat transfer from the diaphragm end 22 to the sensor element end 24. Alternatively, or to further reduce that heat transfer, a heat sink structure including such as fins or veins 26 may be used. Housing 12 may have a highly polished, or shiny finish to better direct the infra-red radiation emitted from the inner surface 28 of diaphragm 16. Alternatively, a coating 30, which may be highly reflective, or shiny can be made of aluminum or gold. Gold is a preferred choice since it will not oxidize and stays shiny or reflective for an extended time. Thermal infra-red sensor element 14 may be a conventional device including a housing 32, an IR transparent window 34 and a MEMS thermopile 36.

Diaphragm 16 has a thin configuration along the direction of axis 18. Typically on the order of approximately 20-60 thousandths of an inch. Diaphragm 16 is preferably made of a low thermal mass, high thermal conductivity material, such as, for example, stainless steel, Inconel or aluminum oxide. Diaphragm 16 has an outer surface 38 that absorbs the heat 39 from medium 40, a solid or fluid, and emits from its inner surface 42 infra-red radiation 44. Inner surface 42 may have a coating 46 in the nature of a non-shiny black body to increase emissivity, typically an oxidized material e.g. aluminum oxide.

A mounting flange, hex nut 48, may be employed for mounting sensor 10 in an application using, for example, threads 50.

In operation heat 39 from medium 40 is absorbed by the outer surface 38 of diaphragm 16 and then emitted by inner surface 42, or coating 46, as infra-red radiation within the narrow field of view 20, e.g. ±8 degrees of sensor element 14. Preferably, diaphragm 16 fills substantially the entire field of view 20 of sensor element 14.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

1. A sensor for sensing the temperature of a medium comprising:
a housing;
a thermal infra-red sensor element having a predetermined field of view and disposed in said housing; and
a diaphragm closing said housing and spaced along an axis from and in the field of view of said thermal sensor element, said diaphragm configured to absorb on its outer surface heat from the medium, said diaphram further configured to emit radiation from its inner surface to said thermal sensor element representative of the temperature of the medium.

2. The infra-red temperature sensor of claim 1 in which said thermal sensor element is at one end of said housing and said diaphragm is at the other.

3. The infra-red temperature sensor of claim 1 in which said housing is in the shape of an elongate cylinder.

4. The infra-red temperature sensor of claim 1 in which said housing is in the shape of a right circular cylinder.

5. The infra-red temperature sensor of claim 1 in which said housing is made of a low thermal conducting material.

6. The infra-red temperature sensor of claim 5 in which said housing is made of steel.

7. The infra-red temperature sensor of claim 5 in which said housing is made of ceramic.

8. The infra-red temperature sensor of claim 1 in which said housing comprises a shiny finish.

9. The infra-red temperature sensor of claim 8 in which said housing further comprises a coating material including one of gold, platinum and aluminum.

10. The infra-red temperature sensor of claim 1 in which said thermal sensor element includes a thermopile.

11. The infra-red temperature sensor of claim 10 in which said thermopile includes a MEMS thermopile.

12. The infra-red temperature sensor of claim 1 in which said diaphragm has a thin configuration along the direction of said axis.

13. The infra-red temperature sensor of claim 12 in which said diaphragm is approximately 20-60 thousandths thick along said axis.

14. The infra-red temperature sensor of claim 12 in which said diaphragm is made of a low thermal mass, high thermal conductivity material.

15. The infra-red temperature sensor of claim 14 in which said low thermal mass, high thermal conductivity material includes stainless steel, Inconel or aluminum oxide.

16. The infra-red temperature sensor of claim 1 in which said diaphragm has high thermal emissivity on its inner surface.

17. The infra-red temperature sensor of claim 1 in which said diaphragm is coated with a high thermal emissivity material on its inner surface.

18. The infra-red temperature sensor of claim 17 in which said high thermal emissivity material includes an oxidized material.

19. The infra-red temperature sensor of claim 1 in which said housing includes mounting threads and a mounting member.

20. The infra-red temperature sensor of claim 19 in which said mounting member includes a hexagonal configuration.

21. The infra-red temperature sensor of claim 1 in which said housing includes external heat sink fins.

22. The infra-red temperature sensor of claim 1 in which said medium is a fluid.
